(19) United States
(12) Patent Application Publication
(10) Pub. No.: US 2014/0154464 A1
(43) Pub. Date: Jun. 5, 2014

(54) GRAPHENE MEMBRANE WITH SIZE-TUNABLE NANOSCALE PORES

(71) Applicant: Empire Technology Development, LLC, Wilmington, DE (US)

(72) Inventors: Seth Adrian Miller, Englewood, CO (US); Gary L. Duerksen, Ward, CO (US)

(73) Assignee: Empire Technology Development, LLC, Wilmington, DE (US)

(21) Appl. No.: 13/985,523

(22) PCT Filed: Nov. 30, 2012
(86) PCT No.: PCT/US12/67392

§ 371 Date: Aug. 14, 2013

(51) Int. Cl. B01D 39/20

(52) U.S. Cl. CPC B01D 39/2055
USPC 428/137; 216/41; 156/345.24

(57) ABSTRACT

Technologies are generally described for a graphene membrane with uniformly-sized nanoscale pores that may be prepared at a desired size using colloidal lithography. A graphene monolayer may be coated with colloidal nanoparticles using self-assembly, followed by off-axis metal layer deposition, for example. The metal layer may form on the colloidal nanoparticles and on portions of the graphene not shadowed by the nanoparticles. The nanoparticles may be removed to leave a negative metal mask that exposes the underlying graphene through holes left by the removed nanospheres. The bare graphene may be etched to create pores using an oxygen plasma or similar material, while leaving metal-masked regions intact. Pore size may be controlled according to size of colloidal nanoparticles and angle of metal deposition relative to the substrate. The process may result in a dense, hexagonally packed array of uniform holes in graphene for use as a membrane, especially in liquid separations.

### BACKGROUND

Unless otherwise indicated herein, the materials described in this section are not prior art to the claims in this application and are not admitted to be prior art by inclusion in this section.

Graphene monolayers are one-atom-thick planar sheets of sp2-bonded carbon atoms with unique physical properties. For example, porous graphene may be desirable for membrane separation. Theoretical and experimental studies indicate that atom-scale holes in the graphene lattice may provide significant selectivity for separating species based on molecular size. Further, monolayer graphene, at one atom thick, may be a desirable candidate because the permeation rate through a membrane may increase with decreasing membrane thickness. Consequently, porous graphene membranes may be of interest for potentially outperforming conventional polymeric membranes. For example, in water filtration, nanoscale pores may be desirable since virus particles may be as small as 20 nm in diameter. Such small pores may be below the range of diffractive optical patterning, and application of cutting-edge semiconductor patterning may be prohibitively expensive.

A graphene membrane with uniformly sized pores may be effective for many uses. Polymer membranes typically contain pores with a wide distribution of sizes, and may achieve high selectivity because the filtrate traverses multiple pores in the membrane and may be statistically likely to traverse a small (size-limiting) pore in passage. In a monolayer graphene membrane, the filtrate may traverse the membrane only once, and a fabrication process that creates pores with a similar statistical distribution in sizes may lead to poor selectivity.

Although porous graphene has shown interesting performance in small-scale academic studies, current preparation methods may not be capable of preparing a graphene membrane with uniformly sized pores. Known porous graphene examples have been created using a physical process such as electron or ion beams to damage the graphene surface, followed by oxidative expansion of the defects to create pores. Such methods have created porous graphene membranes with pores that vary significantly in size and in areal density over the membrane.

The present disclosure appreciates that preparing porous graphene, e.g., for use in separation membranes, may be a complex undertaking.

### SUMMARY

The following summary is illustrative only and is not intended to be in any way limiting. In addition to the illustrative aspects, embodiments, and features described above, further aspects, embodiments, and features will become apparent by reference to the drawings and the following detailed description.

The present disclosure generally describes methods, apparatus, and computer program products for providing a porous graphene membrane with size-tunable nanoscale pores.

According to various examples, a membrane is described. The membrane may include a graphene monolayer perforated by an array of nanoscale pores. The array of nanoscale pores may be characterized by a substantially uniform pore diameter. The array of nanoscale pores may also be in a substantially hexagonal arrangement.

According to some examples, methods of preparing a porous membrane are described. Some methods may include positioning a graphene monolayer on a support substrate in a deposition chamber with a sample manipulator. Some methods may also include forming an array of colloid particles on a surface of the graphene monolayer. The colloid particles may be formed sufficient to define a shadow-masked fraction and an unmasked fraction of the surface of the graphene monolayer. Some methods may also include coating a metal film on at least a portion of the unmasked fraction of the surface of the graphene monolayer. Some methods may also include removing the colloid particles from the shadow-masked fraction of the surface of the graphene monolayer. Some methods may further include etching the shadow-masked fraction of the surface of the graphene monolayer to form an array of nanoscale pores in the graphene monolayer. Some methods may also include releasing the graphene monolayer from the support substrate to form the porous membrane.

According to several examples, a system for manufacturing a porous membrane is described. The system may include: a deposition chamber; a sample manipulator; a colloid deposition source; a metal deposition source; a colloid removal apparatus; an etchant source; and a microprocessor. The sample manipulator may be configured to hold a graphene monolayer at a support substrate in the deposition chamber. The metal deposition source and the sample manipulator may be cooperatively configured to provide off-axis deposition of a metal film to a surface of the graphene monolayer held at the sample manipulator. The microprocessor may be coupled to the deposition chamber, the sample manipulator, the colloid deposition source, the metal deposition source, the colloid removal apparatus, and the etchant source. The microprocessor may be configured via machine executable instructions to control the colloid deposition source and the sample manipulator effective to deposit an array of colloid particles on the surface of the graphene monolayer such that the colloid particles define a shadow-masked fraction and an unmasked fraction of the surface. Instructions may also be included to control the metal deposition source and the sample manipulator effective to coat a metal film on at least a portion of the unmasked fraction of the surface of the graphene monolayer. Instructions may also be included to control the colloid removal apparatus effective to remove the colloid particles from the shadow-masked fraction of the surface of the graphene monolayer. The microcontroller may also control the etchant source to etch the shadow-masked fraction of the surface of the graphene monolayer effective to form an array of nanoscale pores in the graphene monolayer. Instructions may further be included to control the sample manipulator effective to release the graphene monolayer from the support substrate to form the porous membrane.

According to various examples, a computer-readable storage medium is described. The computer readable storage medium may have machine executable instructions stored thereon for manufacturing a porous membrane. The machine executable instructions may include instructions to control a colloid deposition source and a sample manipulator effective to deposit an array of colloid particles on a surface of a graphene monolayer such that the colloid particles define a shadow-masked fraction and an unmasked fraction of the surface of the graphene monolayer. Instructions may be included to control a metal deposition source and a sample manipulator effective to coat a metal film on at least a portion of the unmasked fraction of the surface of the graphene monolayer. Instructions may also be included to control a colloid removal apparatus effective to remove the colloid particles from the shadow-masked fraction of the surface of the graphene monolayer. Instructions may further be included to control an etchant source to etch the shadow-masked fraction of the surface of the graphene monolayer effective to form an array of nanoscale pores in the graphene monolayer. Instructions may also be included to control the sample manipulator effective to release the graphene monolayer from the support substrate to form the porous membrane.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments arranged in accordance with the disclosure and are, therefore, not to be considered limiting of its scope, the disclosure will be described with additional specificity and detail through use of the accompanying drawings, in which:

FIG. 1A is a conceptual illustration representative of colloid arrays at graphene monolayers;

FIG. 1B is an electron micrograph of an example substantially hexagonal close packed colloid array;

FIG. 1C is a conceptual illustration representative of colloid arrays at graphene monolayers, coated with metal films;

FIG. 2 is a conceptual illustration viewed in cross section through a representative colloid array at a graphene monolayer, illustrating example aspects of depositing metal layers;

FIG. 3 is a conceptual illustration representative of metal layer-graphene monolayer composites after removal of colloid arrays;

FIG. 4A is a conceptual illustration representative of metal layer-graphene monolayer composites after etching of nanopore arrays in graphene monolayers;

FIG. 4B is a conceptual illustration representative of porous graphene monolayers after removal of metal layers;

FIG. 5 is a flow diagram showing example operations that may be used for carrying out the described methods of forming a nanopore array in a graphene monolayer;

FIG. 6A is a block diagram representative of automated machines that may be used for carrying out the described methods of forming a nanopore array in a graphene monolayer;

FIG. 6B is a conceptual diagram representative of automated machines in the process of forming a colloid array on a surface of a graphene monolayer to form a shadow-masked fraction of the surface of the graphene monolayer;

FIG. 6C is a conceptual diagram representative of automated machines depositing a metal film on a colloid array;

FIG. 6D is a conceptual diagram representative of automated machines removing a colloid array from a shadow-masked fraction of a surface of a graphene monolayer after depositing a metal film;

FIG. 6E is a conceptual diagram representative of automated machines etching a shadow-masked fraction of a surface of the graphene monolayer to form an array of nanoscale pores in a graphene monolayer;

FIG. 6F is a conceptual diagram representative of automated machines etching a remaining metal film from a surface of a graphene monolayer;

FIG. 6G is a conceptual diagram representative of automated machines releasing a graphene monolayer from a support substrate to form a porous membrane;

FIG. 7 is an illustration representative of general purpose computing devices that may be used to control the automated machine of FIG. 6A or similar equipment in carrying out the described method of forming a nanopore array in a graphene monolayer; and

FIG. 8 illustrates a block diagram representative of computer program products that may be used to control the automated machine of FIG. 6A or similar equipment in carrying out the described method of forming a nanopore array in a graphene monolayer; all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to compositions, methods, apparatus, systems, devices, and/or computer program products related to providing a porous graphene membrane with size-tunable nanoscale pores.

Briefly described, a graphene membrane may be prepared with uniformly-sized nanoscale pores at a desired size using colloidal lithography. In one example technique, a graphene monolayer may be coated with colloidal nanoparticles using self-assembly, followed by off-axis metal layer deposition, for example. Further, the metal layer may be formed on the nanoparticles and on portions of the graphene not shadowed by the nanoparticles. The colloidal nanoparticles may be removed to leave a negative metal mask that exposes the underlying graphene through holes left by the removed nanospheres. The bare graphene may be etched to create pores using an oxygen plasma or similar material, while leaving metal-masked regions intact. Pore size may be controlled according to size of colloidal nanoparticles and angle of metal deposition relative to the substrate. The process may result in a dense, hexagonally packed array of uniform holes in graphene for use as a membrane, especially in liquid separations.

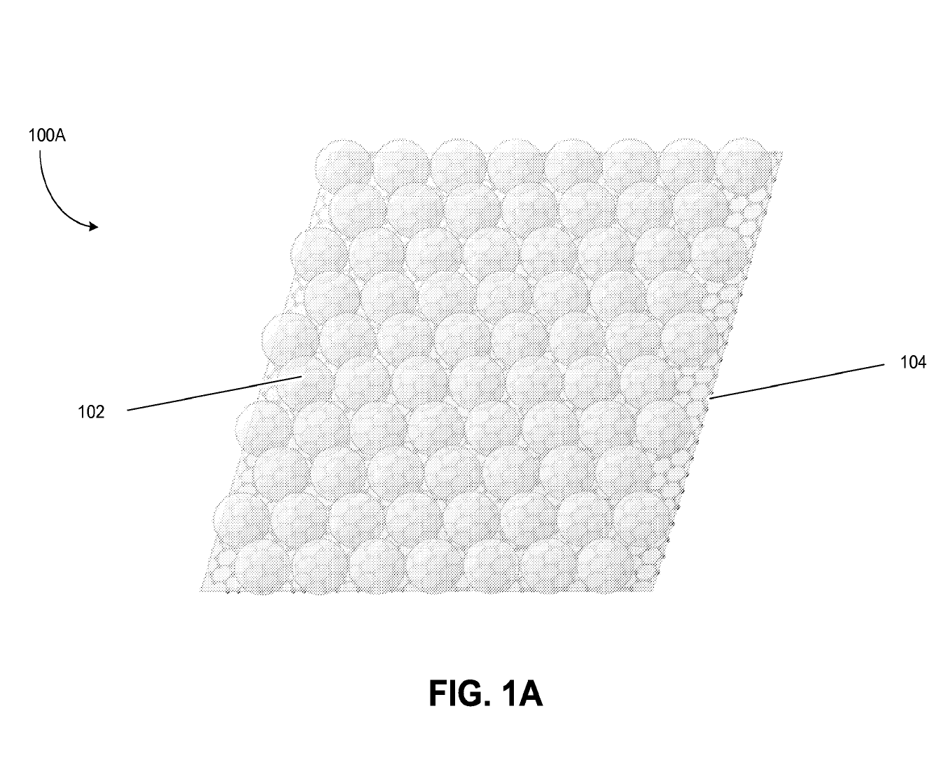

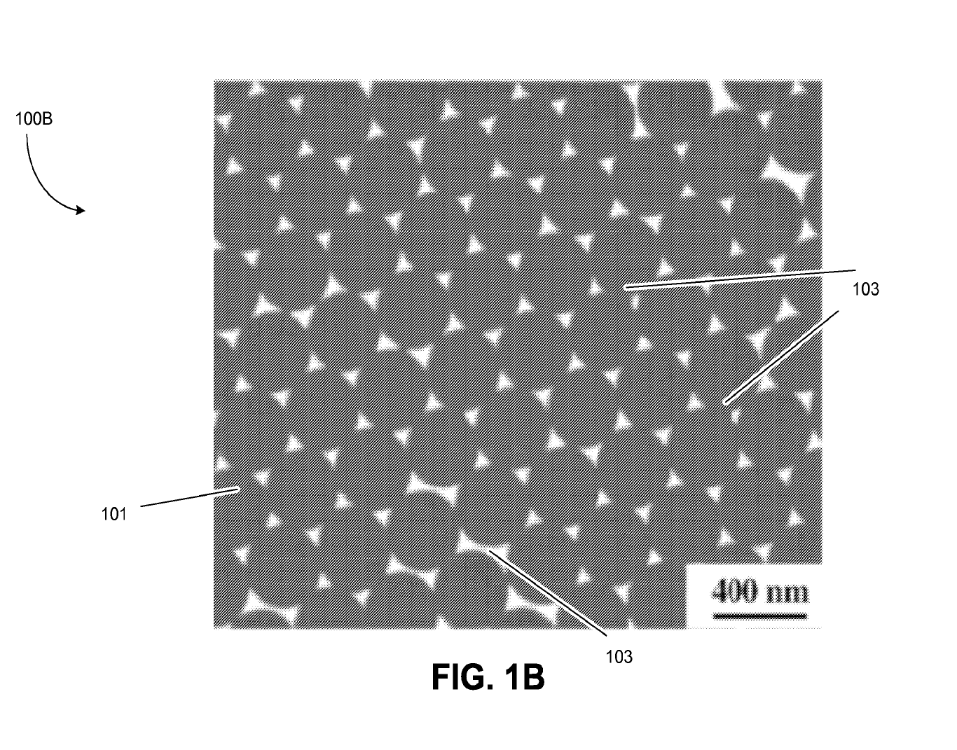

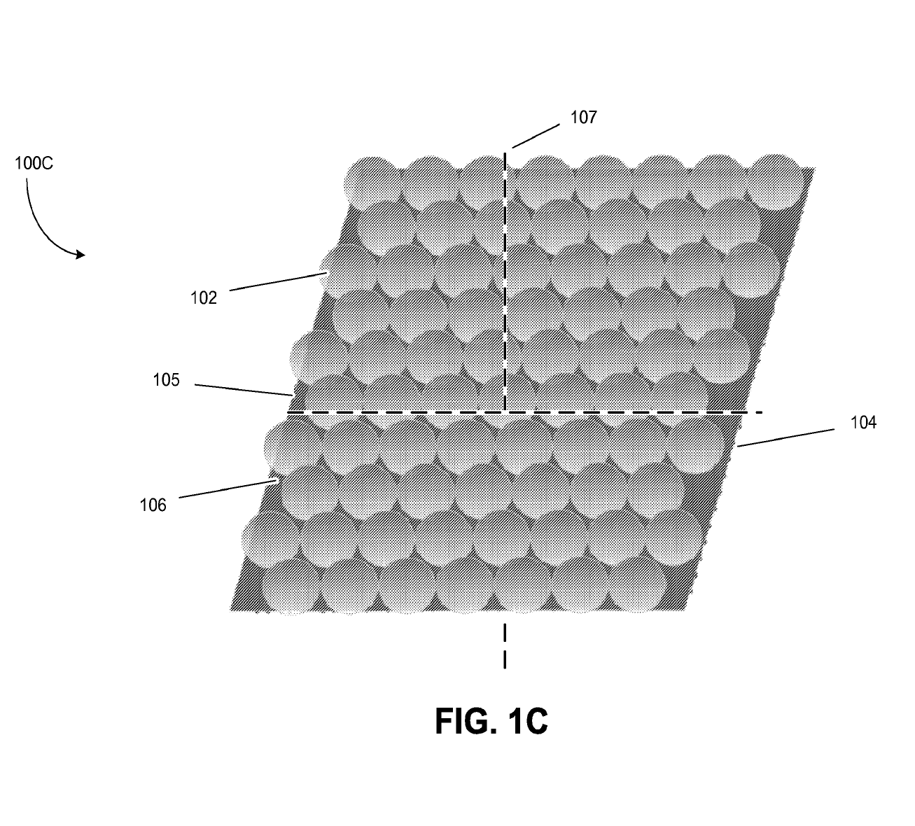

FIG. 1A is a conceptual illustration representative of colloid arrays at graphene monolayers, arranged in accordance with at least some embodiments herein. Colloid array 100A may include colloidal nanoparticles 102, positioned on graphene monolayer 104 as depicted in FIG. 1A. The colloid array 100A of the colloidal nanoparticles 102 may form a shadow mask at the surface of the graphene monolayer 104 where the location of each colloid nanoparticle 102 may correspond to the location of a nanopore to be formed, as described herein.

The colloid array 100A may be formed by any variety colloidal self-assembly techniques. For example, a fluid suspension of colloidal nanoparticles 102 may be contacted to graphene monolayer 104 by dip coating, spin coating, spray coating, or curtain coating. For example, dip coating the graphene monolayer 104 into a fluid suspension of colloidal nanoparticles 102 may lead to colloidal self-organization through forces exerted by capillary action and evaporation. In another example, spin coating may drive colloidal self-organization through forces exerted by spin shear and capillary action. A fluid suspension of colloidal nanoparticles 102 may also be contacted to graphene monolayer 104 by printing methods coupled with capillary and evaporation forces. Examples of printing methods include as ink-jet printing, contact printing, offset printing, or flexography. Colloidal nanoparticles 102 may also be placed on the graphene monolayer 104 by examples such as: chemical or electrochemical colloid deposition using a patterned array; colloid self-organization guided by physical templates; electrophoretic colloid deposition; and contact-lifting by pressing the graphene monolayer 104 on to a pre-existing colloid array sufficient to cause adherence of the colloidal nanoparticles 102, followed by lifting the graphene monolayer 104 together with the colloid array 100A.

Each of the preceding example techniques may be used to form colloid array 100A by assembling colloidal nanoparticles 102 on graphene monolayer 104 in a substantially hexagonal close packed arrangement as depicted in FIG. 1A. As used herein, the term “substantially hexagonal close packed” means that a substantial fraction of the colloidal nanoparticles may be in mutual contact and may exhibit order characteristic of two-dimensional hexagonal crystals. The term “substantially hexagonal close packed” further means that the colloid array 100A may also exhibit dislocations, lattice imperfections, or other defects that may be found in imperfect two-dimensional crystalline materials.

FIG. 1B is an electron micrograph of an example substantially hexagonal close packed colloid array, arranged in accordance with at least some embodiments herein. The colloid array 100B may be in a substantially hexagonal close packed arrangement of colloid particles 101 and at the same time may include various imperfections 103.

Suitable materials for the colloidal nanoparticles 102 may include, for example, inorganic materials such as silica, silicon, a metal, or an inorganic compound of a metal such as alumina. Suitable materials for the colloidal nanoparticles 102 may also include organic polymers, for example, a polystyrene, a polyacrylate, a polycarbonate, a polyalkane, a polyalkene, a polyester, a polyacrylonitrile, and/or a mixture thereof. The colloidal nanoparticles 102 may also include combinations of such materials, for example, combinations of inorganic and organic materials such as in a core shell nanoparticle. A wide variety of suitable colloidal nanoparticles may be commercially available in dry form or in fluid suspension (see, e.g., MKIC USA Inc., Williamsville, N.Y.; Corpuscular, Inc., Cold Spring, N.Y., Spherotech, Lake Forest, Ill.; Nanomi B. V., Oldenzaal, Netherlands).

The colloidal nanoparticles may be characterized by an average diameter in a range from about 1 nanometer to about 10 micrometers. The colloidal nanoparticles 102 may be selected with an average diameter that may be about equal to or greater than the diameter of the nanopores desired. In various examples, the nanoparticles may be substantially monodisperse with respect to diameter. For example, the average diameter of the colloidal nanoparticles may be characterized by a standard deviation of less than about ±10%, less than about ±5%, less than about ±2%, less than about ±1%, less than about ±0.5%, or less than about ±0.1%. The nanoparticles may also be characterized by a substantially spherical shape.

FIG. 1C is a conceptual illustration representative of colloid arrays at graphene monolayers, coated with metal films, all arranged in accordance with at least some embodiments described herein. Metal-colloid array 100C may include a metal layer 106 coated on both the colloidal nanoparticles 102 and the graphene monolayer 104. The metal layer 106 may be applied by any suitable method, such as beam methods and solvent methods described herein. Suitable metals for inclusion in metal layer 106 may include one or more of Be, Mg, Al, Ca, Sc, Ti, V, Cr, Mn, Fe, Co, Ni, Cu, Zn, Ga, Sr, Y, Zr, Nb, Mo, Tc, Ru, Rh, Pd, Ag, Cd, In, Sn, Ba, Hf, Ta, W, Re, Os, Ir, Pt, Au, Tl, Pb, and/or Bi.

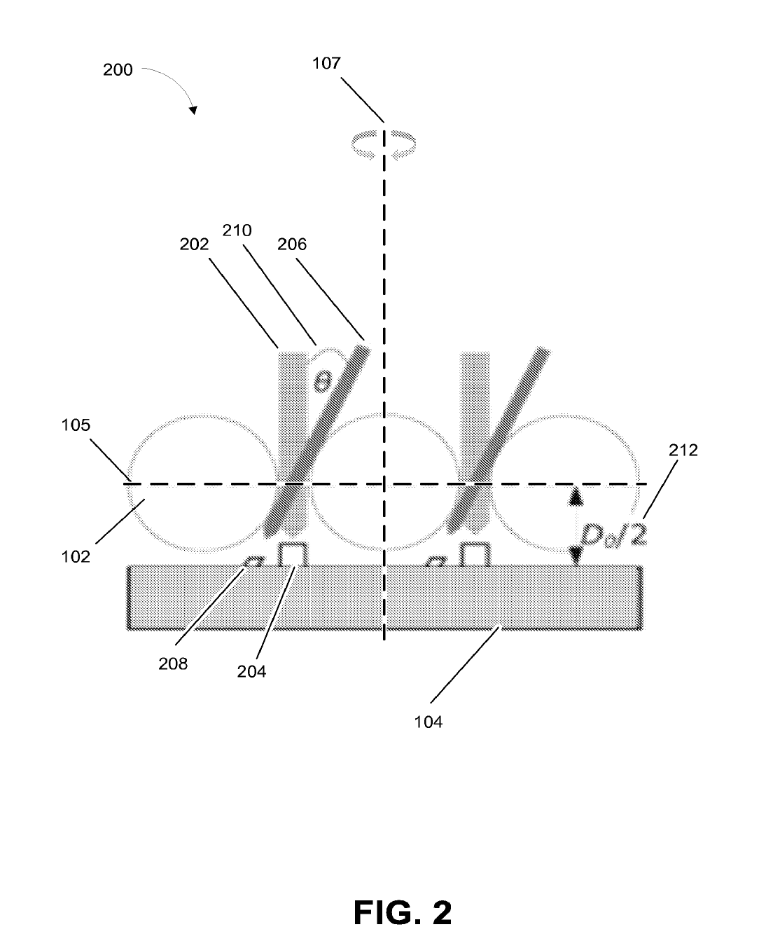

In FIG. 1C, axes 105 and 107 are presented to provide reference between FIG. 1C and FIG. 2. Axis 105 may run through the indicated row of colloidal nanoparticles 102 and may be parallel to the surface of graphene monolayer 104. Axis 107 may be perpendicular to the surface of graphene monolayer 104 and intersects axis 105. Together, axes 105 and 107 define a cross sectional viewing plane that is depicted in FIG. 2 for illustrating aspects of depositing the metal layer by on-axis and off−axis beam methods.

FIG. 2 is a conceptual illustration viewed in cross section through a representative colloid array at a graphene monolayer, illustrating example aspects of depositing metal layers, all arranged in accordance with at least some embodiments described herein. For example, beam deposition may be conducted using on-axis beam 202. Suitable beam deposition methods may include one of: ion beam deposition, metal sputtering, electron beam evaporation, chemical vapor deposition, or atomic layer deposition. As used herein, “on-axis” means a direction substantially perpendicular to graphene monolayer 104, e.g., parallel to axis 107. An “on-axis” beam casts an on-axis shadow under each of the colloidal nanoparticles 102. Metal provided by on-axis beam 202 may be deposited on areas 204 of graphene monolayer 104. The metal deposited by on-axis beam 202 may coat the colloidal nanoparticles 102 and unshadowed portions of the graphene monolayer at area 204. The colloidal nanoparticles 102 may cast a shadow under on axis beam 202 such that on-axis beam 202 may not deposit metal at area 208. Likewise, on-axis beam 202 may not deposit metal at the graphene monolayer 104 wherever colloidal nanoparticles 102 may be in mutual contact.

Beam deposition may also be conducted using off-axis beam 206 to deposit metal in areas shadowed by the colloidal nanoparticles 102. As used herein, “off-axis” means a direction at an angle 210 to the on-axis direction. Examples of angle 210 may range between perpendicular and parallel to the graphene monolayer. For example, suitable angles may be at an angle off perpendicular to the graphene monolayer 104 of: between about 5 and about 85 degrees, between about 10 and about 75 degrees, between about 15 and about 60 degrees, or between about 20 and about 50 degrees. Metal provided by off-axis beam 206 may be deposited on areas 208 of graphene monolayer 104. Off-axis metal deposition may be made more uniform by rotating the graphene monolayer 104 or the off axis beam 206 as indicated by the arrows about axis 107. Rotation plus off-axis deposition may deposit metal on a greater area compared to either on-axis deposition or off-axis deposition without rotation. Rotation plus off-axis deposition may deposit metal layer 106 on the graphene monolayer 104 between the colloidal nanoparticles 102, even between colloidal nanoparticles 102 that contact each other to create a shadow under on-axis deposition. The approximate diameter of the shadow-masked area under each colloidal nanoparticle 102 may be estimated for spherical nanoparticles by multiplying the colloid diameter by (1/sin(angle 210)−1). For example, for a 100 nanometer diameter spherical nanoparticle under 45° off-axis deposition, the approximate diameter of the shadow-masked area may be calculated as)100*(1/sin(45°−1) or about 40 nanometers.

In other examples metal layer 106 may be applied by any method which permits metal to be deposited in areas that would be shadowed by the colloidal nanoparticles 102, such as solvent methods. Solvent methods such as electroplating or redox precipitation may deposit metal at any solvent accessible surface. Surfaces which may not be solvent accessible may include mutual contacts among colloidal nanoparticles 102 and contacts between colloidal nanoparticles 102 and graphene monolayer 104.

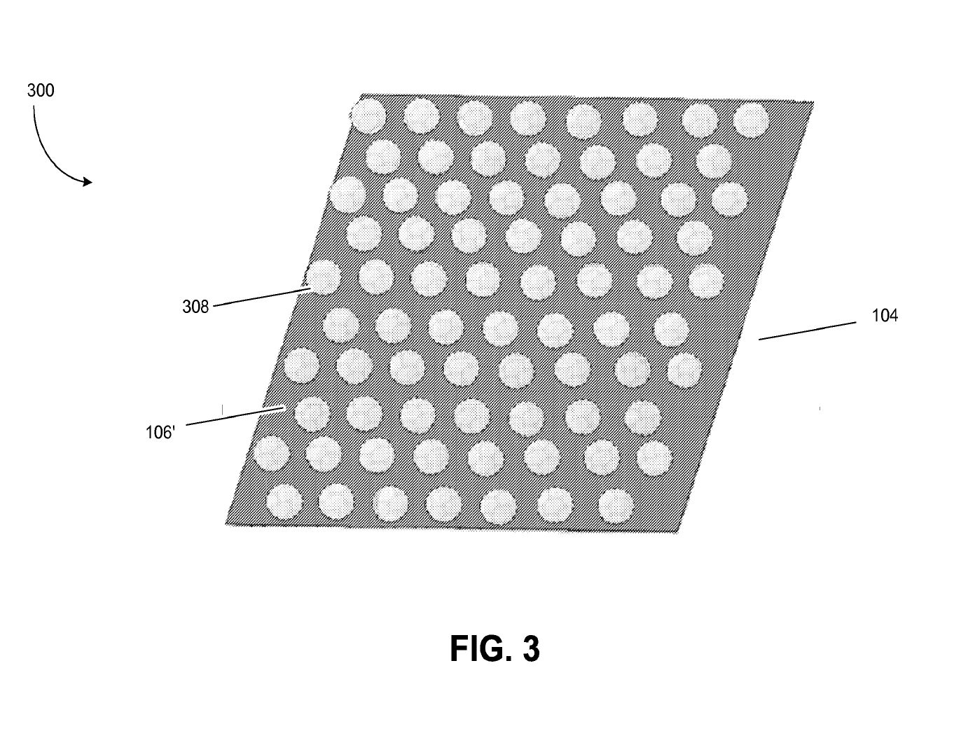

FIG. 3 is a conceptual illustration representative of metal layer-graphene monolayer composites after removal of colloid arrays, arranged in accordance with at least some embodiments described herein. Graphene-metal composite 300 may include the graphene monolayer 104, coated with the metal film 106′, with nanopores 308 in the metal film 106′. Bare portions of graphene monolayer 104 may be exposed through the nanopores 308 in the metal film 106′.

The nanopores 308 may correspond to portions of graphene monolayer 104 that may be shadow-masked by the colloid nanoparticles 102 in colloid array 100A and metal-colloid array 100C, particularly under the metal deposition conditions employed, such as off-axis deposition. Collectively, the metal film 106′ and the nanopores 308 therein may define a negative metal mask.

Graphene-metal composite 300 may be formed by removing the colloidal nanoparticles 102 from the metal-colloid array 100C. In some examples, colloidal nanoparticles 102 may be removed by etching using suitable etching solutions depending on the composition and known solubility of the colloidal nanoparticles 102. For example, silicon may be etched with a solution of potassium hydroxide; silicon dioxide may be etched with a solution of hydrofluoric acid buffered with ammonium fluoride; and polystyrene and polycarbonate may be dissolved with acetone. Etching techniques may be combined with mechanical dislodgment, such as by sonication during etching. In several examples, colloidal nanoparticles 102 may also be removed by contact-lifting, which may include contacting an adhesive layer onto the colloidal nanoparticles 102 and lifting the adhesive layer together with the colloidal nanoparticles 102. In other examples, the colloidal nanoparticles may be removed by contacting the colloidal nanoparticles 102 with a corresponding suspending fluid and sonicating the fluid to dislodge the colloidal nanoparticles 102 from the graphene monolayer 104.

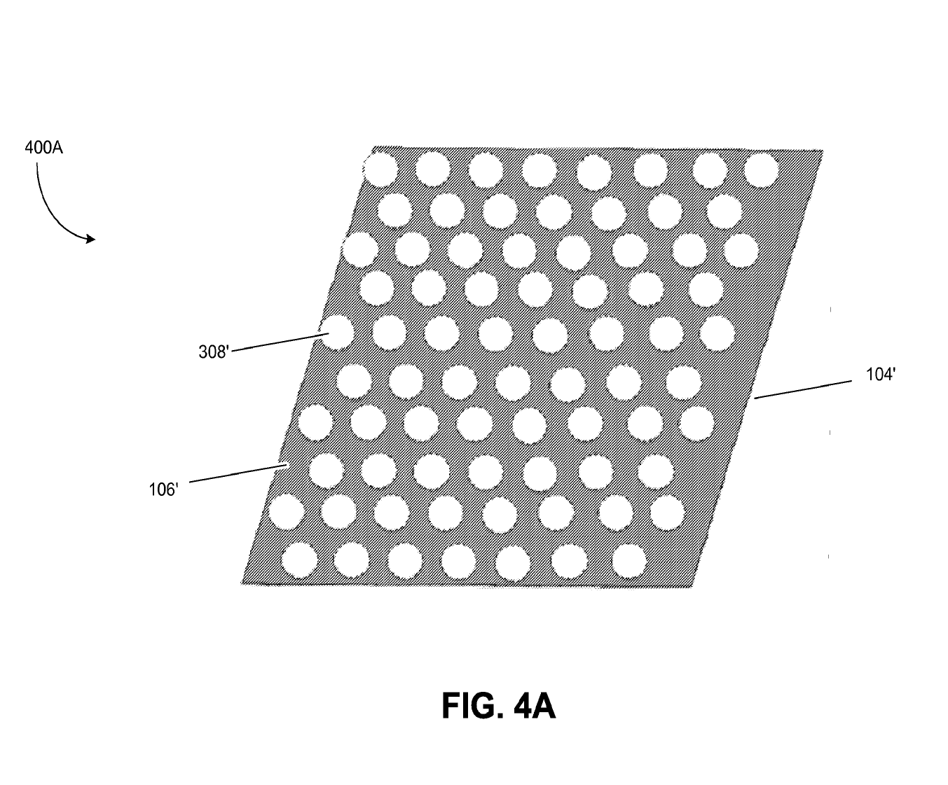

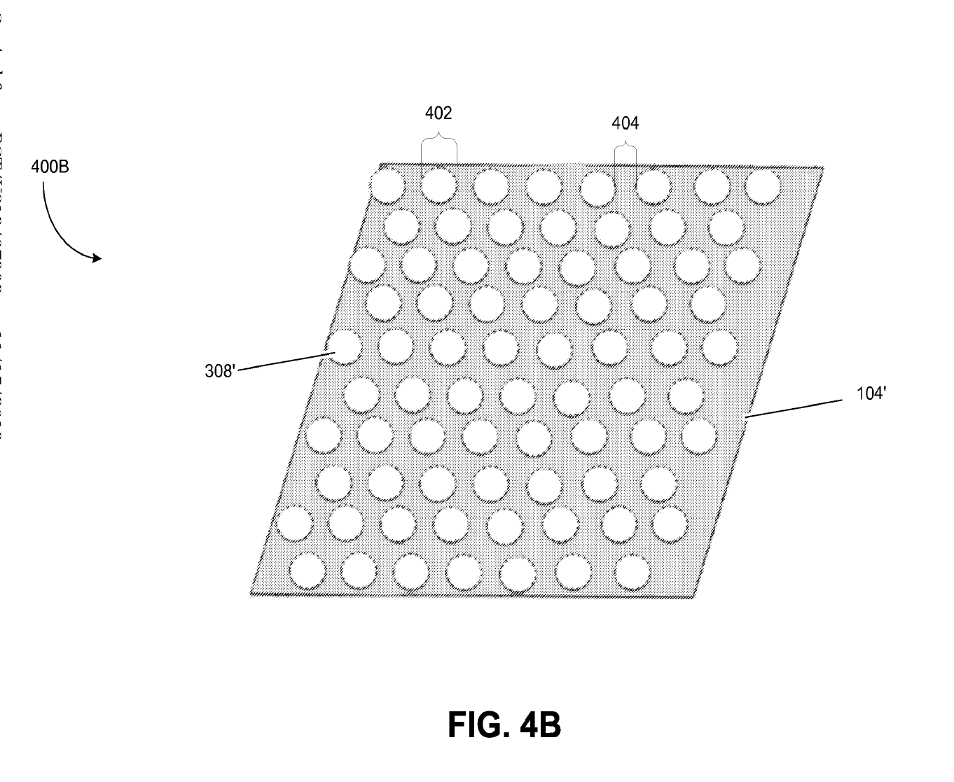

FIG. 4A is a conceptual illustration representative of metal layer-graphene monolayer composites after etching of nanopore arrays in graphene monolayers, arranged in accordance with at least some embodiments described herein. Porous graphene-metal composite 400A may include a porous graphene monolayer 104′ coated with the metal film 106′. Graphene-metal composite 400A may include nanopores 308′ through both the metal film 106′ and the graphene monolayer 104′. The nanopores 308′ may be formed by etching the bare graphene metal composite 300 with an oxygen plasma. The oxygen plasma may etch bare portions of graphene monolayer 104 exposed through the nanopores 308 in the metal film 106′.

FIG. 4B is a conceptual illustration representative of porous graphene monolayers after removal of metal layers, arranged in accordance with at least some embodiments described herein. Porous graphene membrane 400B may include the graphene monolayer 104′ and an array of nanopores 308′. The nanopores 308′ may be collectively characterized by an average diameter 402. The average diameter 402 may be in a range from about 1 nanometer to about 10 micrometers. The average diameter 402 may be characterized by a percent standard deviation of less than about ±10%, for example, less than about ±5%, less than about ±2%, less than about ±1%, less than about ±0.5%, or less than about ±0.1%. In some examples, the nanopores 308′ may be substantially monodisperse with respect to diameter 402. The nanopores 308′ may also be collectively characterized by an average nanopore separation 404. The average nanopore separation 404 may be in a range from about 1 nanometer to about 10 micrometers. The average nanopore separation 404 may be characterized by a percent standard deviation of less than about ±10%, for example, less than about ±5%, less than about ±2%, less than about ±1%, less than about ±0.5%, or less than about ±0.1%. In some examples, the nanopores 308′ may form a substantially regular array with respect to the average nanopore separation 404.

Porous graphene membrane 400B may be formed from porous graphene-metal composite 400A by removing the metal layer 106′ from the graphene monolayer 104′. Suitable techniques for removing the metal layer 106′ may include etching using a solution that dissolves the metal film 106′. Suitable etching solutions may be selected according to the composition of the metal film. For example, copper may be etched with a solution of ferric chloride; silver may be etched with a solution of ferric nitrate; and gold may be etched with a solution of iodine and potassium iodide. A wide variety of suitable solutions may be commercially available for etching various metals (e.g., Transene Co. Inc, Danvers Mass.). In some examples, the metal layer 106′ may also be separated from the graphene monolayer 104′ by contact-lifting, which may include contacting adhesive layers to one or both of the metal layer 106′ and the graphene monolayer 104′, and lifting the adhesive layers to separate the metal layer 106′ and the graphene monolayer 104′. Suitable adhesive layers may be commercially available as adhesive tapes (3M Co., St. Paul, Minn.).

FIG. 4B illustrates several aspects of the deposition techniques described for FIG. 2. With the techniques described under FIG. 2, a tightly packed colloid array such as colloid array 100A in FIG. 1A may lead to a regular array of nanopores 308′ that may be smaller in diameter 402 compared to the colloidal nanoparticles 102. This further demonstrates that the size of nanopores 308′ may be controlled by selection of colloidal nanoparticle sizes and metal deposition parameters such as the off-axis deposition angle 210. Furthermore, the methods described under FIG. 2 may produce a substantial separation 404 between the nanopores 308′ even though the colloidal nanoparticles 102 in colloid array 100A may be tightly packed. Having a substantial separation 404 increases the amount of graphene remaining in the porous graphene membrane 400B, which may increase structural strength.

The array of nanopores 308/308′ may be in a substantially hexagonal arrangement as depicted in FIGS. 3, 4A, and 4B. As used herein, the term “substantially hexagonal” means that a substantial fraction of the nanopores 308 may exhibit order characteristic of two-dimensional hexagonal crystals, with an inter-pore separation 404. The term “substantially hexagonal” further means that the nanopores 308/308′ may also exhibit dislocations, lattice imperfections, or other defects that may be found in imperfect two-dimensional crystalline materials.

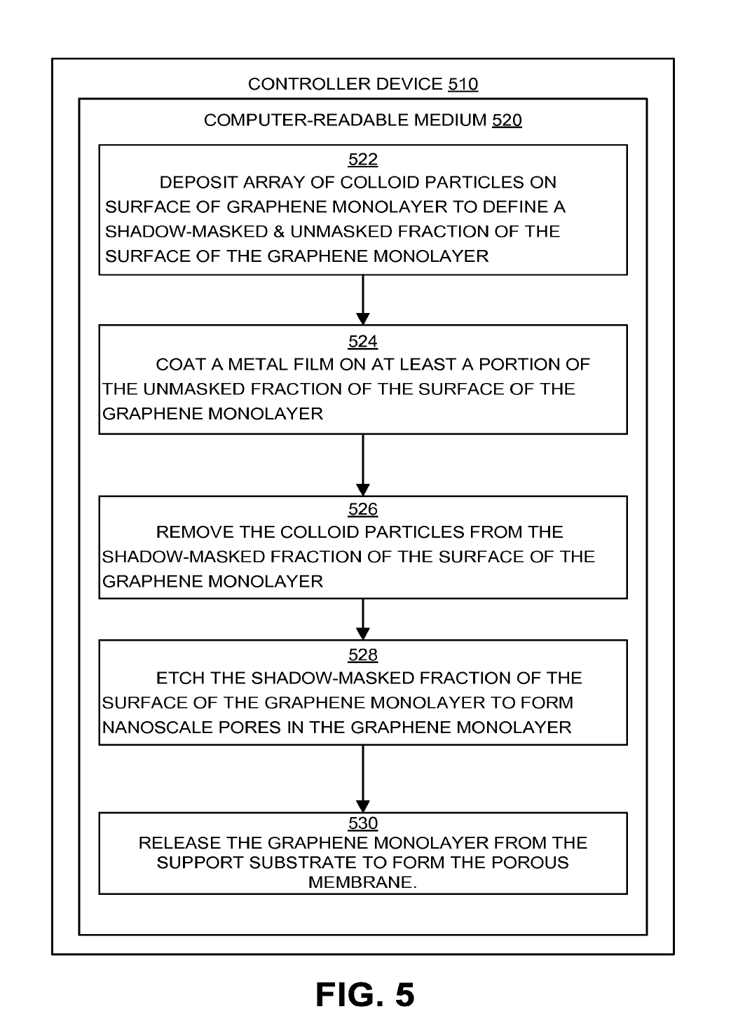

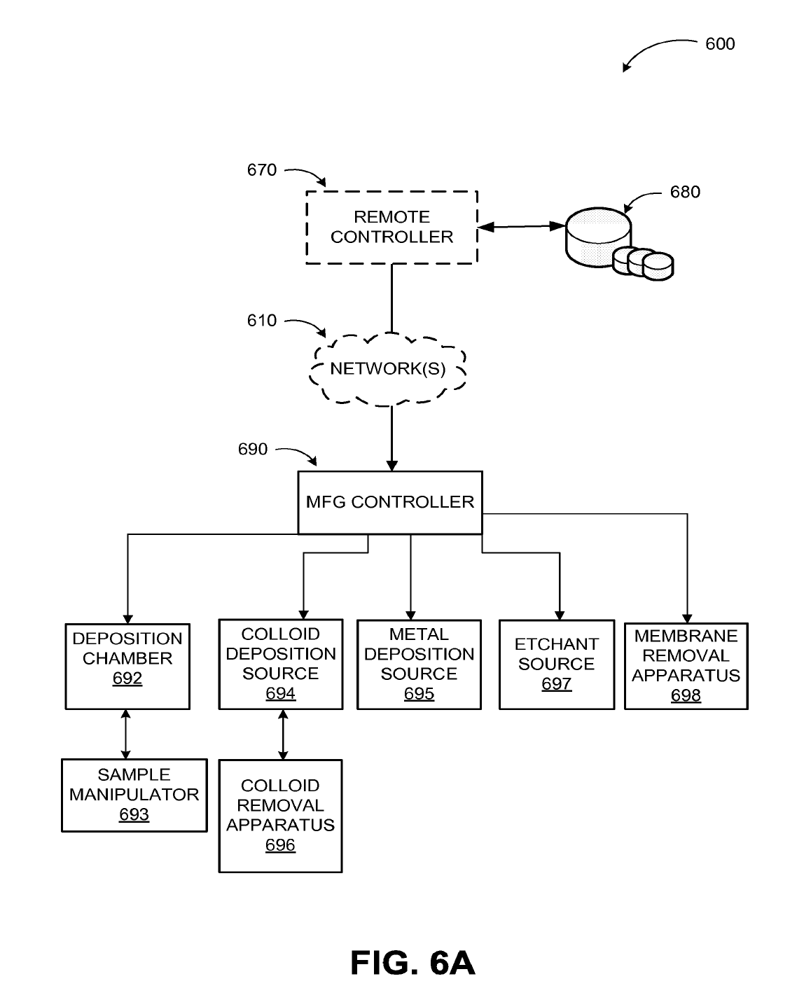

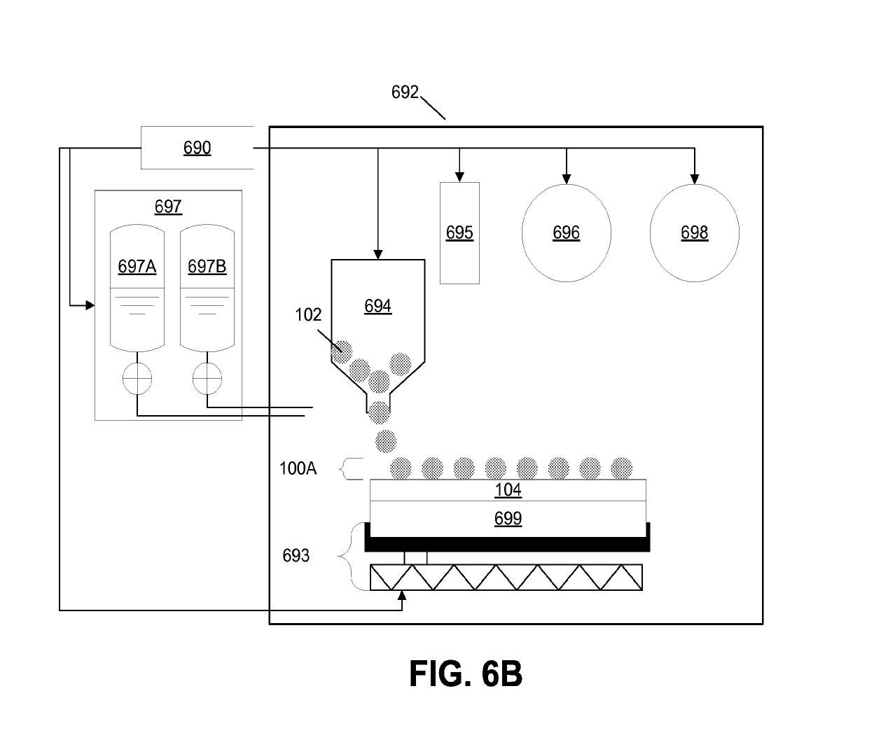

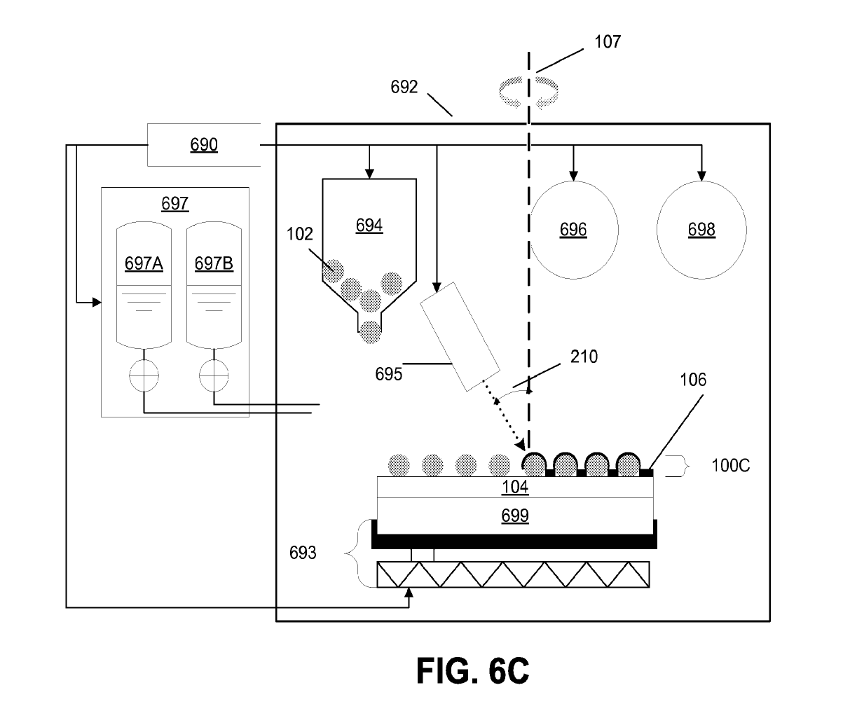

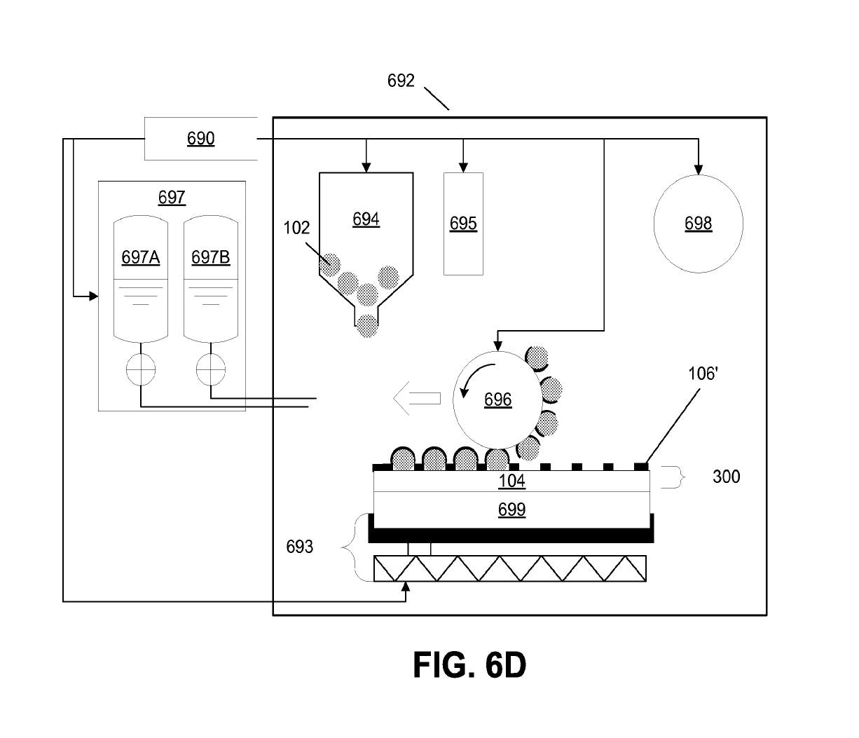

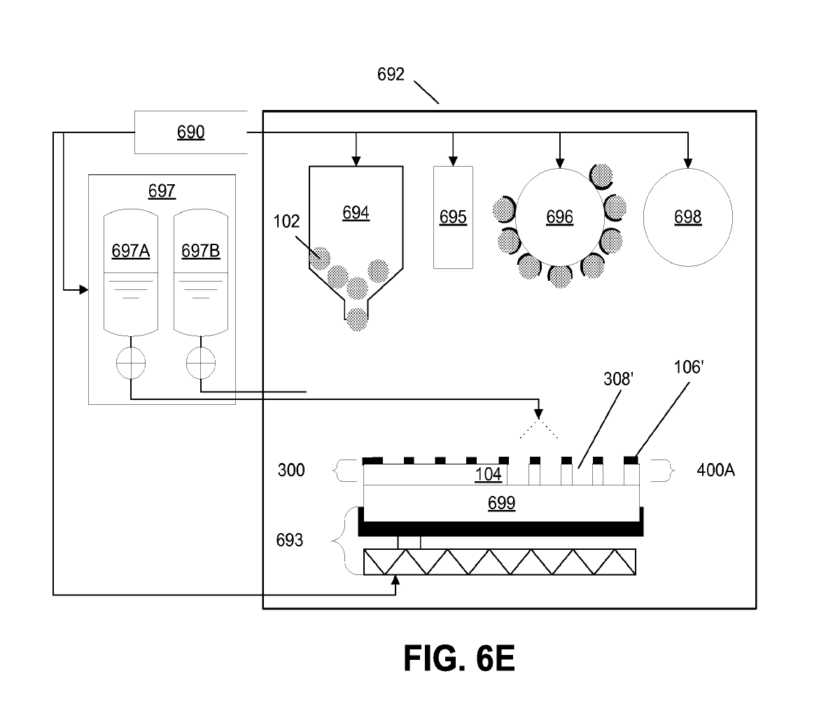

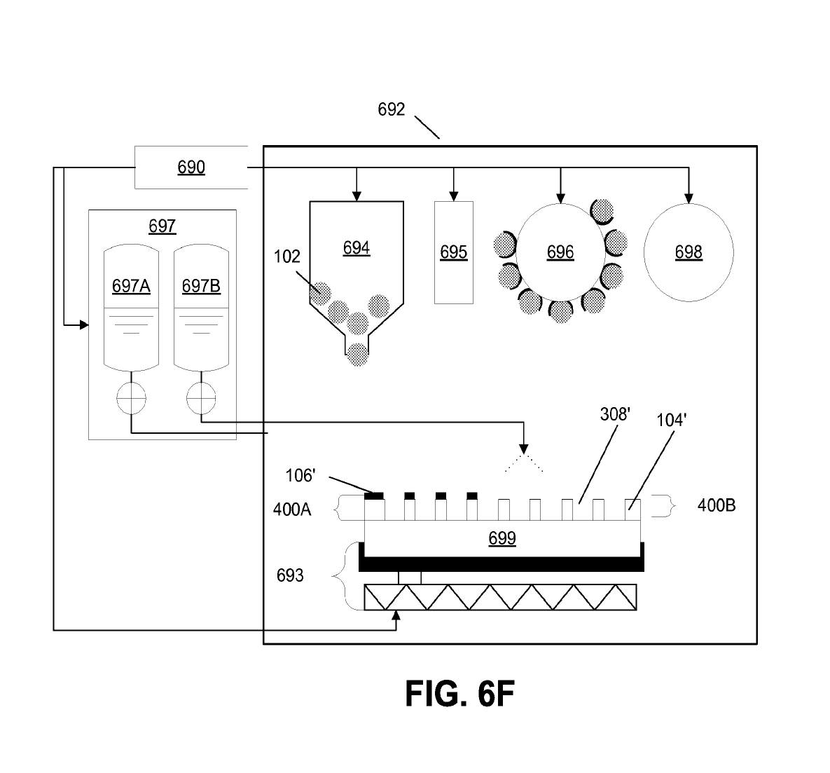

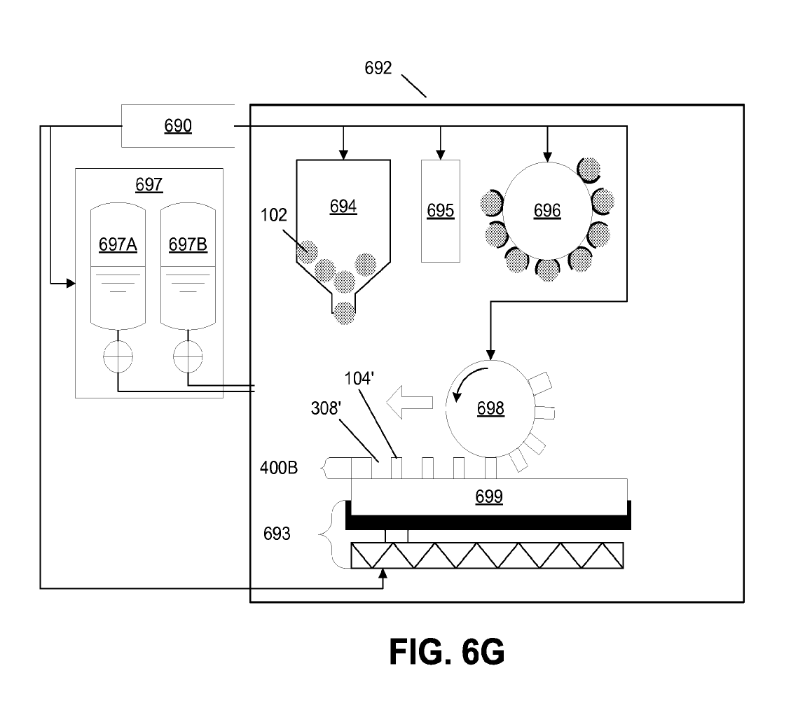

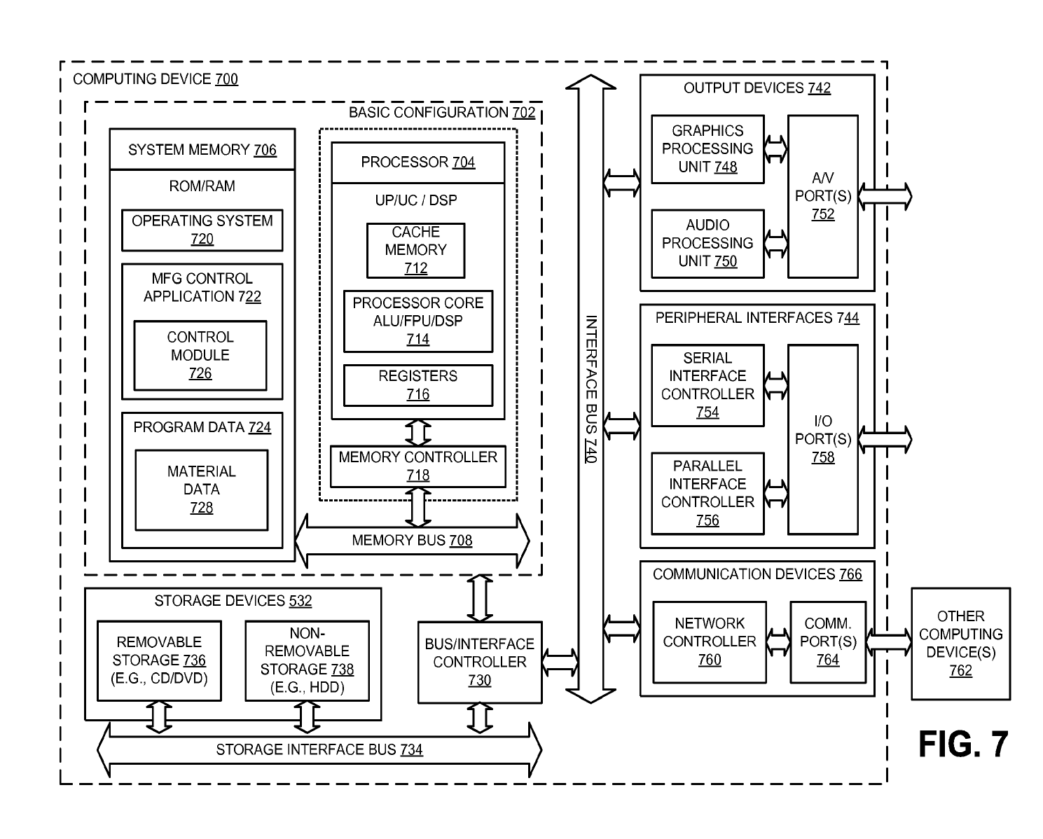

FIG. 5 is a flow diagram showing example operations that may be used for carrying out the described methods of forming a nanopore array in a graphene monolayer, arranged in accordance with at least some embodiments described herein. A process of manufacturing a nanopore array in a graphene monolayer as described herein may include one or more operations, functions or actions as may be illustrated by one or more of operations 522, 524, 526, 528, and/or 530. Example methods of manufacturing nanopore arrays in a graphene monolayer as described herein may be operated by a controller device 510, which may be embodied as computing device 700 in FIG. 7 or a special purpose controller such as manufacturing controller 690 of FIG. 6A, or similar devices configured to execute instructions stored in computer-readable medium 520 for controlling the performance of the method.

Some example processes may begin with operation 522 “DEPOSIT ARRAY OF COLLOID PARTICLES ON SURFACE OF GRAPHENE MONOLAYER EFFECTIVE TO DEFINE A MASK.” The mask may include shadow masked and unmasked fractions of the surface of the graphene monolayer. Operation 522 may include any technique of forming a self-assembled colloid array as described herein, for example, by applying a fluid suspension of colloid particles to the graphene monolayer by dip coating, spin coating, spray coating, or curtain coating.

Operation 522 may be followed by operation 524, “COAT A METAL FILM ON AT LEAST A PORTION OF THE UNMASKED FRACTION OF THE SURFACE OF THE GRAPHENE MONOLAYER.” Operation 524 may include any technique of depositing a metal film as described herein, for example, by ion beam deposition, metal sputtering, electron beam evaporation, chemical vapor deposition, or atomic layer deposition.

Operation 524 may be followed by operation 526, “REMOVE THE COLLOID PARTICLES FROM THE SHADOW-MASKED FRACTION OF THE SURFACE OF THE GRAPHENE MONOLAYER.” Operation 526 may be conducted by any removal technique described herein. For example, the colloid particles may be etched or dissolved, such as dissolving polystyrene or polycarbonate colloid particles using acetone. The colloid particles may be removed by adhesive contact, such as by pressing an adhesive tape onto the colloid particles and removing the tape together with the colloid particles. In another example, the colloid particles may be removed by dislodging via sonication in a suspending fluid, for example, sonicating polystyrene colloid particles in water.

Operation 526 may be followed by operation 528, “ETCH THE SHADOW-MASKED FRACTION OF THE SURFACE OF THE GRAPHENE MONOLAYER TO FORM NANOSCALE PORES IN THE GRAPHENE MONOLAYER.” Operation 528 may be conducted by any suitable technique of graphene etching. For example, the graphene monolayer may be etched by exposure to an oxygen plasma.

Operation 528 may be followed by operation 530, “RELEASE THE GRAPHENE MONOLAYER FROM THE SUPPORT SUBSTRATE TO FORM THE POROUS MEMBRANE.” The graphene monolayer may be released from the support substrate by any suitable technique depending on the support substrate. For example, for graphene supported on a copper layer, operation 532 may include contacting the copper layer with a suitable copper etching solution, such as ferric chloride. Operation 532 may also include contact-lifting adhesive techniques, such as contacting the graphene monolayer with a porous adhesive support membrane and removing the porous adhesive support membrane and the graphene monolayer from the substrate.

The operations included in the process of FIG. 5 described above are for illustration purposes. A process of forming a nanopore array in a graphene monolayer as described herein may be implemented by similar processes with fewer or additional operations. In some examples, the operations may be performed in a different order. In some other examples, various operations may be eliminated. In still other examples, various operations may be divided into additional operations, or combined together into fewer operations. Although illustrated as sequentially ordered operations, in some implementations the various operations may be performed in a different order, or in some cases various operations may be performed at substantially the same time. For example, any other similar process may be implemented with fewer, different, or additional operations so long as such similar processes form the nanopore array in the graphene monolayer.

FIG. 6A is a block diagram representative of automated machines that may be used for carrying out the described methods of forming a nanopore array in a graphene monolayer, arranged in accordance with at least some embodiments described herein. Automated machine 600 may be operated, for example, as described herein using the process operations outlined in FIG. 5.

As illustrated in FIG. 6A, a manufacturing controller 690 may be coupled one or more machines that may be employed to carry out the operations described in FIG. 5, for example, one or more of: a deposition chamber 692; a sample manipulator 693; a colloid deposition source 694; a metal deposition source 695; a colloid removal apparatus 696; an etchant source 697; and a membrane removal apparatus 698.

Manufacturing controller 690 may be operated by human control, by a remote controller 670 via network 610, or by machine executed instructions such as might be found in a computer program. Data associated with controlling the different processes of manufacturing graphene may be stored at and/or received from data stores 680. Further, the individual elements of manufacturing system 600 may be implemented as any suitable device configured in any suitable fashion for carrying out the operations described herein.

For example, sample manipulator 693 may be stationary or may include one or more moving functions, such as translation in zero, one, two, or three perpendicular axes, rotation in one, two, or three perpendicular axes, or combinations thereof. Such moving functions may be provided by motors, linear actuators, or piezoelectric actuators. Such moving functions may be provided in combination with moving functions for other elements of manufacturing system 600. For example, to provide off-axis deposition, either or both of sample manipulator 693 and metal source 695 may be moved relative to each other to provide metal deposition at an off-axis angle, such as angle 210 in FIG. 2. Further, metal deposition source 695 may be configured for any approach for depositing the metal layer, such as by sputtering, evaporation, atomic or chemical vapor deposition, or high purity electroplating. Also, etchant source 697 may be configured for providing multiple etchants, for example, a polymer solvent to etch/dissolve the colloidal nanoparticles during removal, a suitable graphene etchant such as an oxygen plasma, and a suitable metal etchant for removing the metal layer.

FIGS. 6B-6G are exemplary schematics of components of manufacturing system 600, configured to demonstrate the process operations outlined in FIG. 5, all arranged in accordance with at least some embodiments described herein.

For example, FIG. 6B is a conceptual diagram representative of automated machines in the process of forming a colloid array on a surface of a graphene monolayer to form a shadow-masked fraction of the surface of the graphene monolayer, arranged in accordance with at least some embodiments herein. In FIG. 6B, the automated machine 600 is depicted in the process of forming the colloid array 100A on a surface of graphene monolayer 104 using colloidal nanoparticles 102. Graphene monolayer 104 may be held at a substrate 699 by sample manipulator 693. Sample manipulator 693 may be located in manufacturing/deposition chamber 692. Manufacturing controller 690 may control sample manipulator 693 and colloid depositor 694 to deposit colloidal nanoparticles 102 at graphene monolayer 104. For example, colloid depositor 694 may be a reservoir that delivers a suspension of colloidal nanoparticles 102 to the surface of graphene monolayer 104 on command from manufacturing controller 690. Sample manipulator 693 may be configured to rotate on command from manufacturing controller 690, providing a spin coating action to the suspension of colloidal nanoparticles 102.

FIG. 6C is a conceptual diagram representative of automated machines depositing a metal film on a colloid array, arranged in accordance with at least some embodiments herein. In FIG. 6C, manufacturing controller 690 may direct metal deposition source 695, such as a metal sputter source, to coat colloidal array 100A and graphene monolayer 104 with metal layer 106 to form metal coated array 100C. Manufacturing controller 690 may control metal deposition source 695 to deposit the metal layer 106 at an off-axis angle 210. Further, manufacturing controller 690 may control sample manipulator 693 to rotate about axis 107 during off-axis coating as described herein.

FIG. 6D is a conceptual diagram representative of automated machines removing a colloid array from a shadow-masked fraction of a surface of a graphene monolayer after depositing a metal film, arranged in accordance with at least some embodiments herein. In FIG. 6D, colloid removal apparatus 696 may be directed by manufacturing controller 690 to remove the metal-coated colloidal nanoparticles 106/102 to leave the metal-coated graphene composite 300. As depicted in this example, colloid removal apparatus 696 may be a roller coated with an adhesive that contacts and physically removes the metal-coated colloidal nanoparticles 106/102.

FIG. 6E is a conceptual diagram representative of automated machines etching a shadow-masked fraction of a surface of the graphene monolayer to form an array of nanoscale pores in a graphene monolayer, arranged in accordance with at least some embodiments herein. In FIG. 6E, manufacturing controller 690 may direct etchant source 697 to provide an appropriate graphene etchant. For example, etchant source 697A may be an oxygen plasma source that etches the graphene exposed in metal-graphene composite 300 to form pores 308′ in graphene monolayer 104.

FIG. 6F is a conceptual diagram representative of automated machines etching a remaining metal film from a surface of a graphene monolayer, arranged in accordance with at least some embodiments herein. In FIG. 6F, manufacturing controller 690 may direct etchant source 697 to provide an appropriate metal etchant to remove the remaining metal layer 106′, forming porous graphene 400B. For example, when metal layer 106′ may include gold, etchant source 697B may deliver a solution of potassium iodide and iodine as a gold etchant.

FIG. 6G is a conceptual diagram representative of automated machines releasing a graphene monolayer from a support substrate to form a porous membrane, arranged in accordance with at least some embodiments herein. In FIG. 6G, manufacturing controller 690 may direct membrane removal apparatus 698 to contact porous graphene membrane 400B. As depicted in this example, graphene membrane removal apparatus 698 may be a roller that carries an adhesive, porous support web. As graphene membrane removal apparatus 698 rolls across the sample manipulator, the porous graphene membrane 400B may adhere to the adhesive support web and may be removed from the substrate 699.

The apparatus elements described above for FIGS. 6A-6G are for illustration purposes. An apparatus for forming a nanopore array in a graphene monolayer as described herein may be implemented by similar apparatus with fewer or additional elements. In some examples, the apparatus elements may be configured locations or in different order. In some other examples, various apparatus elements may be eliminated. In still other examples, various apparatus elements may be divided into additional apparatus elements, or combined together into fewer apparatus elements. Any other similar automated machine may be implemented with fewer, different, or additional apparatus elements so long as such similar automated machines form a nanopore array in a graphene monolayer.

FIG. 7 illustrates a general purpose computing device that may be used to control the automated machine 600 of FIG. 6A or similar equipment in carrying out the described method of forming a nanopore array in a graphene monolayer, arranged in accordance with at least some embodiments described herein. In a basic configuration 702, referring to the components within the dashed line, computing device 700 typically may include one or more processors 704 and a system memory 706. A memory bus 708 may be used for communicating between processor 704 and system memory 706.

Depending on the desired configuration, processor 704 may be of any type including but not limited to a microprocessor (μP), a microcontroller (μC), a digital signal processor (DSP), or any combination thereof. Processor 704 may include one more levels of caching, such as a level cache memory 712, a processor core 714, and registers 716. Processor core 714 may include an arithmetic logic unit (ALU), a floating point unit (FPU), a digital signal processing core (DSP Core), or any combination thereof. An example memory controller 718 may also be used with processor 704, or in some implementations memory controller 718 may be an internal part of processor 704.

Depending on the desired configuration, system memory 706 may be of any type including but not limited to volatile memory (such as RAM), non-volatile memory (such as ROM, flash memory, etc.) or any combination thereof. System memory 706 may include an operating system 720, one or more manufacturing control applications 722, and program data 724. Manufacturing control application 722 may include a control module 726 that may be arranged to control manufacturing system 600 of FIG. 6A and any other processes, operations, techniques, methods and functions as discussed above. Program data 724 may include, among other data, material data 728 for controlling various aspects of the manufacturing system 600.

Computing device 700 may have additional features or functionality, and additional interfaces to facilitate communications between basic configuration 702 and any required devices and interfaces. For example, a bus/interface controller 730 may be used to facilitate communications between basic configuration 702 and one or more data storage devices 732 via a storage interface bus 734. Data storage devices 732 may be removable storage devices 736, non-removable storage devices 738, or a combination thereof. Examples of removable storage and non-removable storage devices may include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 706, removable storage devices 736 and non-removable storage devices 738 may be examples of computer storage media. Computer storage media may include, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 700. Any such computer storage media may be part of computing device 700.

Computing device 700 may also include an interface bus 740 for facilitating communication from various interface devices (e.g., output devices 742, peripheral interfaces 744, and communication devices 766 to basic configuration 702 via bus/interface controller 730. Output devices 742 may include a graphics processing unit 748 and an audio processing unit 750, which may be configured to communicate to various external devices such as a display or speakers via one or more AN ports 752. Example peripheral interfaces 744 include a serial interface controller 754 or a parallel interface controller 756, which may be configured to communicate with external devices such as input devices (e.g., keyboard, mouse, pen, voice input device, touch input device, etc.) or other peripheral devices (e.g., printer, scanner, etc.) via one or more I/O ports 758. A communication device 766 may include a network controller 760, which may be arranged to facilitate communications with one or more other computing devices 762 over a network communication link via one or more communication ports 764.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 700 may be implemented as a portion of a physical server, virtual server, a computing cloud, or a hybrid device that include any of the above functions. Computing device 700 may also be implemented as a personal computer including both laptop computer and non-laptop computer configurations. Moreover computing device 700 may be implemented as a networked system or as part of a general purpose or specialized server.

Networks for a networked system including computing device 700 may include any topology of servers, clients, switches, routers, modems, Internet service providers, and any appropriate communication media (e.g., wired or wireless communications). A system according to embodiments may have a static or dynamic network topology. The networks may include a secure network such as an enterprise network (e.g., a LAN, WAN, or WLAN), an unsecure network such as a wireless open network (e.g., IEEE 802.11 wireless networks), or a world-wide network such (e.g., the Internet). The networks may also include multiple distinct networks that may be adapted to operate together. Such networks may be configured to provide communication between the nodes described herein. By way of example, and not limitation, these networks may include wireless media such as acoustic, RF, infrared and other wireless media. Furthermore, the networks may be portions of the same network or separate networks.

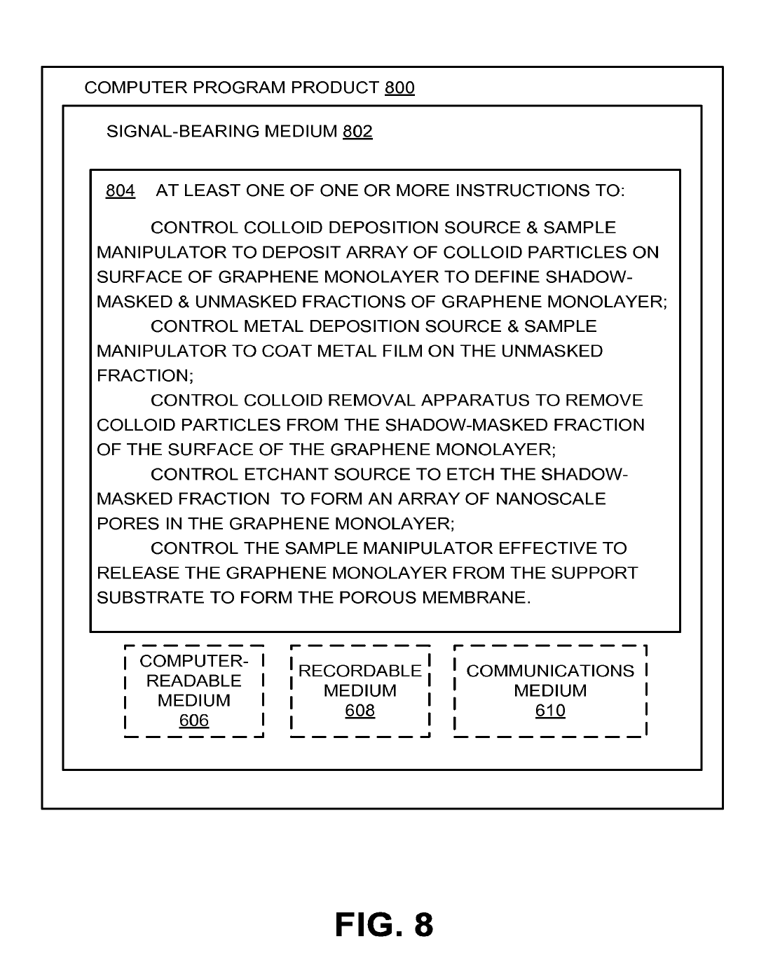

FIG. 8 illustrates a block diagram representative of computer program products that may be used to control the automated machine of FIG. 6A or similar equipment in forming a nanopore array in a graphene monolayer, arranged in accordance with at least some embodiments described herein. In some examples, as shown in FIG. 8, computer program product 800 may include a signal bearing medium 802 that may also include machine readable instructions 804 that, when executed by, for example, a processor, may provide the functionality described above with respect to FIG. 5 through FIG. 7. For example, referring to manufacturing controller 690, one or more of the tasks shown in FIG. 8 may be undertaken in response to machine readable instructions 804 conveyed to the imaging controller 690 by signal bearing medium 802 to perform actions associated with forming a nanopore array in a graphene monolayer as described herein. Some of those instructions may include, for example, one or more instructions to: “control colloid deposition source & sample manipulator to deposit array of colloid particles on surface of graphene monolayer to define shadow-masked & unmasked fractions of graphene monolayer;” “control metal deposition source & sample manipulator to coat metal film on the unmasked fraction;” “control colloid removal apparatus to remove colloid particles from the shadow-masked fraction of the surface of the graphene monolayer;” “control etchant source to etch the shadow-masked fraction to form an array of nanoscale pores in the graphene monolayer;” or “control the sample manipulator effective to release the graphene monolayer from the support substrate to form the porous membrane.”

In some implementations, signal bearing medium 802 depicted in FIG. 8 may encompass a computer-readable medium 806, such as, but not limited to, a hard disk drive, a Compact Disc (CD), a Digital Versatile Disk (DVD), a digital tape, memory, etc. In some implementations, signal bearing medium 802 may encompass a recordable medium 808, such as, but not limited to, memory, read/write (R/W) CDs, R/W DVDs, etc. In some implementations, signal bearing medium 802 may encompass a communications medium 810, such as, but not limited to, a digital and/or an analog communication medium (e.g., a fiber optic cable, a waveguide, a wired communications link, a wireless communication link, etc.). For example, computer program product 800 may be conveyed to the processor 704 by an RF signal bearing medium 802, where the signal bearing medium 802 may be conveyed by a communications medium 810 (e.g., a wireless communications medium conforming with the IEEE 802.11 standard). While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks may be performed by remote processing devices that may be linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that may include instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for providing a configuration environment, which may facilitate configuration of software/hardware products and services for a variety of purposes. Examples of platforms include, but are not limited to, a hosted service executed over multiple servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

EXAMPLE: Polystyrene nanospheres (100 nanometer, Corpuscular, Cold Spring, N.Y.) may be prepared as a 0.5% suspension by weight in distilled, deionized water. The polystyrene nanospheres suspension may be drop-cast onto a flat surface such as a glass slide, and the water may be evaporated so that the polystyrene nanospheres coat the surface of the glass slide. The glass slide may be slowly lowered at about a 30° angle into a bath of distilled, deionized water, which may suspend the polystyrene nanospheres at the air-water interface. The polystyrene nanospheres may self-assemble and pack as a colloidal nanosphere surface layer. Separately, a graphene monolayer may be obtained, supported on a copper foil-silicon substrate. The substrate-supported graphene may be dip-coated by immersing in the bath and withdrawing from the bath. This procedure may draw a close-packed colloidal monolayer of the polystyrene nanospheres along to create the colloidal array of polystyrene nanospheres on the graphene monolayer. The colloid-coated graphene may be placed on a sample manipulator in a deposition chamber of a metal sputtering apparatus. The sample manipulator and the metal sputtering apparatus may be configured to (1) hold the metal sputtering apparatus at a 45° angle with respect to the surface of the colloid coated graphene and (2) rotate the colloid coated graphene and/or the metal sputtering apparatus with about an axis perpendicular to the surface of the colloid coated graphene. The metal sputtering apparatus may be operated to deposit a metal layer such as gold, silver, or chromium on the colloid coated graphene surface. Metal may be deposited on the colloids and on the graphene surface between the colloid nanospheres and partly under the colloid nanospheres. The colloid nanospheres may shadow the deposited metal to leave an uncoated circle of graphene under each colloid nanosphere. The uncoated circle of graphene may have a diameter that may be a fraction of the diameter of the originals sphere of about 1/(sine(deposition angle))−1, or about 40 nanometers based on a colloid diameter of 100 nanometers and a deposition angle of about 45°. The polystyrene spheres may be removed by sonicating in water or toluene, and pores in the graphene may be formed by etching the exposed areas for 10 seconds in a downstream oxygen plasma. The gold metal layer may be removed by etching with an iodine/potassium iodide etching solution (Transene Co. Inc, Danvers Mass.). The porous graphene monolayer may be contacted to a porous adhesive support web contacted with ferric chloride etching solution (Transene Co. Inc, Danvers Mass.) to dissolve the copper foil, washed with distilled, deionized water, and dried. The resulting porous graphene monolayer, supported on the porous adhesive support web, may be used as a separation membrane.

In various examples, a membrane is provided. The membrane may include a graphene monolayer perforated by an array of nanoscale pores. The array of nanoscale pores may be characterized by a substantially uniform pore diameter. The array of nanoscale pores may also be in a substantially hexagonal arrangement.

In some examples, the array of nanoscale pores may be characterized by an average pore diameter in a range between about 1 nanometer and about 10 micrometers. The array of nanoscale pores may be characterized by a standard deviation in pore diameter of about ±10% compared to the average pore diameter. The array of nanoscale pores may be characterized by an average minimum separation between adjacent pore edges in a range between about 1 nanometer and about 10 micrometers. The array of nanoscale pores may be characterized by an average maximum separation between adjacent pore edges in a range between about 1 nanometer and about 10 micrometers.

In several examples, the membrane may further include a metal layer at a first surface of the graphene monolayer. The metal layer may be located at the first surface of the graphene monolayer between the nanoscale pores. The metal layer may include one or more of: Be, Mg, Al, Ca, Sc, Ti, V, Cr, Mn, Fe, Co, Ni, Cu, Zn, Ga, Sr, Y, Zr, Nb, Mo, Tc, Ru, Rh, Pd, Ag, Cd, In, Sn, Ba, Hf, Ta, W, Re, Os, Ir, Pt, Au, Tl, Pb, and/or Bi.

In various examples, a method of preparing a porous membrane is provided. The method may include holding a graphene monolayer on a support substrate in a deposition chamber with a sample manipulator. The method may also include forming an array of colloid particles with a colloid deposition source on a surface of the graphene monolayer. The colloid particles may be formed sufficient to define a shadow-masked fraction and an unmasked fraction of the surface of the graphene monolayer. The method may also include coating a metal film with a metal deposition source on at least a portion of the unmasked fraction of the surface of the graphene monolayer. The method may also include removing the colloid particles with a colloid removal apparatus from the shadow-masked fraction of the surface of the graphene monolayer. The method may further include etching the shadow-masked fraction of the surface of the graphene monolayer with an etchant source to form an array of nanoscale pores in the graphene monolayer. The method may also include releasing the graphene monolayer from the support substrate with a membrane releasing apparatus to form the porous membrane.

In some examples, coating the metal film may further include coating the metal film on the at least a portion of the unmasked fraction of the surface of the graphene monolayer by one of: ion beam deposition, metal sputtering, electron beam evaporation, chemical vapor deposition, atomic layer deposition, electroplating, or redox precipitation. Coating the metal film may include coating the metal film on the at least a portion of the unmasked fraction of the surface of the graphene monolayer by off-axis deposition. Coating the metal film may include coating with one or more of: Be, Mg, Al, Ca, Sc, Ti, V, Cr, Mn, Fe, Co, Ni, Cu, Zn, Ga, Sr, Y, Zr, Nb, Mo, Tc, Ru, Rh, Pd, Ag, Cd, In, Sn, Ba, Hf, Ta, W, Re, Os, Ir, Pt, Au, Tl, Pb, and/or Bi.

In several examples, the method may include removing at least a portion of the metal film from the graphene monolayer after forming the array of nanoscale pores. The method may include forming the array of colloid particles including one of: dip-coating, curtain coating, contact-lift coating, electrophoretic deposition, chemical deposition, electrochemical deposition, physical template guided deposition, spin coating, spray coating, electrostatic coating, inkjet printing, contact printing, offset printing, or flexography. The method may include forming the array of colloid particles on the surface of the graphene monolayer as a substantially hexagonal close packed array. Removing the colloid particles may include one or more of: etching, contact-lifting, and/or sonication. The method may include forming the array of colloid particles including the use of colloid particles that include one or more of: a silica, an alumina, silicon, a metal, a polystyrene, a polyacrylate, a polycarbonate, a polyalkane, a polyalkene, a polyester, a polyacrylonitrile, and/or a mixture thereof.

In many examples, the method may include etching the shadow-masked fraction of the graphene monolayer to form an array of nanoscale pores in the graphene monolayer may include one of: electron beam etching, oxygen plasma etching, or chemical oxidation. The method may include contacting the porous membrane to a porous support substrate with the sample manipulator.

In various examples of the method, etching the shadow-masked fraction of the surface of the graphene monolayer may include etching the nanoscale pores in the graphene monolayer such that the array of nanoscale pores is characterized by a substantially uniform pore diameter. Etching the shadow-masked fraction of the surface of the graphene monolayer may also include etching the nanoscale pores in the graphene monolayer such that the array of nanoscale pores is characterized by an average pore diameter in a range between about 10 nanometers and about 10 micrometers. Etching the shadow-masked fraction of the surface of the graphene monolayer may further include etching the nanoscale pores in the graphene monolayer such that the array of nanoscale pores is characterized by a standard deviation in pore diameter of about ±10% compared to the average pore diameter. Etching the shadow-masked fraction of the surface of the graphene monolayer may also include etching the nanoscale pores in the graphene monolayer such that the array of nanoscale pores is characterized by an average minimum separation between adjacent pore edges in a range between about 1 nanometer and about 10 micrometers.

According to various examples, a system for manufacturing a porous membrane is provided. The system may include: a deposition chamber; a sample manipulator; a colloid deposition source; a metal deposition source; a colloid removal apparatus; an etchant source; and a microprocessor. The sample manipulator may be configured to hold a graphene monolayer at a support substrate in the deposition chamber. The metal deposition source and the sample manipulator may be cooperatively configured to provide off-axis deposition of a metal film to a surface of the graphene monolayer held at the sample manipulator. The microprocessor may be coupled to the deposition chamber, the sample manipulator, the colloid deposition source, the metal deposition source, the colloid removal apparatus, and the etchant source. The microprocessor may be configured via machine executable instructions to control the colloid deposition source and the sample manipulator effective to deposit an array of colloid particles on the surface of the graphene monolayer such that the colloid particles define a shadow-masked fraction and an unmasked fraction of the surface. Instructions may also be included to control the metal deposition source and the sample manipulator effective to coat a metal film on at least a portion of the unmasked fraction of the surface of the graphene monolayer. Instructions may also be included to control the colloid removal apparatus effective to remove the colloid particles from the shadow-masked fraction of the surface of the graphene monolayer. The microcontroller may also control the etchant source to etch the shadow-masked fraction of the surface of the graphene monolayer effective to form an array of nanoscale pores in the graphene monolayer. Instructions may further be included to control the sample manipulator effective to release the graphene monolayer from the support substrate to form the porous membrane.

In some examples, the microprocessor may be further configured via the machine executable instructions to control the sample manipulator to contact the porous membrane to a porous support substrate. The machine executable instructions may be configured to control the metal deposition source and the sample manipulator to coat the metal film by one of: ion beam deposition, metal sputtering, electron beam evaporation, chemical vapor deposition, atomic layer deposition, electroplating, or redox precipitation. The machine executable instructions may be configured to control the metal deposition source and the sample manipulator to coat the metal film by off-axis deposition. The machine executable instructions may also be configured to control the etchant source to etch at least a portion of the metal film from the graphene monolayer after forming the array of nanoscale pores. The machine executable instructions may also be configured to control the etchant source to etch the shadow-masked fraction of the graphene monolayer by one of: electron beam etching, oxygen plasma etching, or chemical oxidation. The machine executable instructions may be configured to control the colloid deposition source to contact the colloid particles to the graphene monolayer by one of: dip-coating, curtain coating, contact-lift coating, electrophoretic deposition, chemical deposition, electrochemical deposition, physical template guided deposition, spin coating, spray coating, electrostatic coating, inkjet printing, contact printing. offset printing, or flexography.

In several examples, the machine executable instructions may be configured to control the colloid removal apparatus to remove the colloid particles by one or more of: etching, contact-lifting, and/or sonication. The machine executable instructions may also be configured to control the etchant source to etch at least a portion of the metal film from the unmasked fraction of the surface of the graphene monolayer after the array of nanoscale pores is formed.

According to various examples, a computer-readable storage medium is provided. The computer readable storage medium may have machine executable instructions stored thereon for manufacturing a porous membrane. The machine executable instructions may include instructions to control a colloid deposition source and a sample manipulator effective to deposit an array of colloid particles on a surface of a graphene monolayer such that the colloid particles define a shadow-masked fraction and an unmasked fraction of the surface of the graphene monolayer. Instructions may be included to control a metal deposition source and a sample manipulator effective to coat a metal film on at least a portion of the unmasked fraction of the surface of the graphene monolayer. Instructions may also be included to control a colloid removal apparatus effective to remove the colloid particles from the shadow-masked fraction of the surface of the graphene monolayer. Instructions may further be included to control an etchant source to etch the shadow-masked fraction of the surface of the graphene monolayer effective to form an array of nanoscale pores in the graphene monolayer. Instructions may also be included to control the sample manipulator effective to release the graphene monolayer from the support substrate to form the porous membrane.

In some examples, the machine executable instructions to control the metal deposition source and the sample manipulator effective to coat the metal film may be configured to control one of: a ion beam depositor, a metal sputtering apparatus, an electron beam evaporator, a chemical vapor deposition apparatus, an atomic layer deposition apparatus, an electroplating apparatus, or an electrochemical apparatus configured to conduct redox precipitation. The machine executable instructions to control the metal deposition source and the sample manipulator effective to coat the metal film may include machine executable instructions to cooperatively control the metal deposition source and the sample manipulator to provide off-axis metal deposition to the graphene monolayer held at the sample manipulator.

In several examples, the machine executable instructions to control the etchant source may be configured to etch at least a portion of the metal film from the graphene monolayer after forming the array of nanoscale pores. The machine executable instructions to control the colloid deposition source and the sample manipulator effective to deposit the array of colloid particles may be configured to control one of: a dip-coater, a curtain coater, a contact-lift apparatus, an electrophoretic depositor, a chemical depositor, an electrochemical depositor, a physical template depositor, a spin coater, a spray coater, an electrostatic coater, an inkjet printer, a contact printer, an offset printer, or a flexographic printer. The machine executable instructions to control the colloid removal apparatus effective to remove the colloid particles may be configured to control one or more of: an etchant source, a contact-lift apparatus, and/or a sonicator. The machine executable instructions to control the etchant source to etch the shadow-masked fraction of the surface of the graphene monolayer may be configured to control one of: an electron beam, an oxygen plasma apparatus, or a chemical oxidation apparatus. The machine executable instructions may be configured to control the sample manipulator to contact the porous membrane to a porous support substrate.

The term “substantially”, as used herein, will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term. For example, the array of nanoscale pores may be in a substantially hexagonal arrangement. In some examples of the substantially hexagonal arrangement, the positions of the pores may deviate from a hexagonal arrangement by an average deviation of a percentage of a side of an average hexagon of the substantially hexagonal arrangement, the percentage being about plus or minus 10%, 9%, 8%, 7%, 6%, 5%, 4%, 3%, 2%, 1%, or less than 1%.

The terms “a” and “an” as used herein mean “one or more” unless the singular is expressly specified. For example, reference to “a base” may include a mixture of two or more bases, as well as a single base.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to, plus or minus 10% of the particular term.

As used herein, the terms “optional” and “optionally” mean that the subsequently described circumstance may or may not occur, so that the description includes instances where the circumstance occurs and instances where it does not.

There is little distinction left between hardware and software implementations of aspects of systems; the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g. as one or more programs running on one or more microprocessors), as firmware, or as virtually any combination thereof, and that designing the circuitry and/or writing the code for the software and or firmware would be well within the skill of one of skill in the art in light of this disclosure.

The present disclosure is not to be limited in terms of the particular embodiments described in this application, which are intended as illustrations of various aspects. Many modifications and variations may be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, systems, or components, which can, of course, vary. It is also to be understood that the terminology used herein is for the purpose of describing particular embodiments only, and is not intended to be limiting.

In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops.

A typical manufacturing system may be implemented utilizing any suitable commercially available components, such as those typically found in data computing/communication and/or network computing/communication systems. The herein described subject matter sometimes illustrates different components contained within, or coupled together with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couple-able”, to each other to achieve the desired functionality. Specific examples of operably couple-able include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group. As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into sub-ranges as discussed above. Finally, as will be understood by one skilled in the art, a range includes each individual member. For example, a group having 1-3 cells refers to groups having 1, 2, or 3 cells. Similarly, a group having 1-5 cells refers to groups having 1, 2, 3, 4, or 5 cells, and so forth. While various aspects and embodiments have been disclosed herein, other aspects and embodiments will be apparent to those skilled in the art.

The various aspects and embodiments disclosed herein are for purposes of illustration and are not intended to be limiting, with the true scope and spirit being indicated by the following claims.

1. A porous membrane, comprising:
a graphene monolayer;
an array of colloid particles on a surface of the graphene monolayer, wherein the colloid particles are formed sufficient to define a shadow-masked fraction and an unmasked fraction of the surface of the graphene monolayer;
a metal film coated on at least a portion of the unmasked fraction of the surface of the graphene monolayer; and
an array of nanoscale pores perforating the graphene monolayer characterized by a substantially uniform pore diameter in a substantially hexagonal arrangement, wherein the array of nanoscales pores are formed when the shadow-masked fraction of the surface of the graphene monolayer is etched upon removal of the array of colloid particles.

2. The membrane of claim 1, wherein the array of nanoscale pores is characterized by an average pore diameter in a range between about 1 nanometer and about 10 micrometers.

3. The membrane of claim 2, wherein the array of nanoscale pores is characterized by a standard deviation in pore diameter of about ±10% compared to the average pore diameter.

4. The membrane of claim 1, wherein the array of nanoscale pores is characterized by an average minimum separation between adjacent pore edges in a range between about 1 nanometer and about 10 micrometers.

5. The membrane of claim 1, wherein the array of nanoscale pores is characterized by an average maximum separation between adjacent pore edges in a range between about 1 nanometer and about 10 micrometers.

6. (canceled)

7. The membrane of claim 1, wherein the metal film includes one or more of: Be, Mg, Al, Ca, Sc, Ti, V, Cr, Mn, Fe, Co, Ni, Cu, Zn, Ga, Sr, Y, Zr, Nb, Mo, Ru, Rh, Pd, Ag, Cd, In, Sn, Ba, Hf, Ta, W, Re, Os, Ir, Pt, Au, Tl, Pb, and/or Bi.

8. A method of preparing a porous membrane, comprising:
positioning a graphene monolayer on a support substrate in a deposition chamber with a sample manipulator;
forming an array of colloid particles on a surface of the graphene monolayer employing a colloid deposition source and the sample manipulator, wherein the colloid particles are formed sufficient to define a shadow-masked fraction and an unmasked fraction of the surface of the graphene monolayer;
coating a metal film on at least a portion of the unmasked fraction of the surface of the graphene monolayer, wherein a metal deposition source and the sample manipulator are cooperatively configured to provide off-axis deposition of the metal film to the surface of the graphene monolayer held at the sample manipulator;
removing the colloid particles from the shadow-masked fraction of the surface of the graphene monolayer employing a colloid removal apparatus;
etching the shadow-masked fraction of the surface of the graphene monolayer to form an array of nanoscale pores in the graphene monolayer employing an etchant source; and
releasing the graphene monolayer from the support substrate to form the porous membrane employing the sample manipulator.

9. The method of claim 8, wherein coating the metal film further comprises coating the metal film on the at least a portion of the unmasked fraction of the surface of the graphene monolayer by one of: ion beam deposition, metal sputtering, electron beam evaporation, chemical vapor deposition, atomic layer deposition, electroplating, or redox precipitation.

10. (canceled)

11. The method of claim 8, wherein coating the metal film further comprises coating with one or more of: Be, Mg, Al, Ca, Sc, Ti, V, Cr, Mn, Fe, Co, Ni, Cu, Zn, Ga, Sr, Y, Zr, Nb, Mo, Tc, Ru, Rh, Pd, Ag, Cd, In, Sn, Ba, Hf, Ta, W, Re, Os, Ir, Pt, Au, Tl, Pb, and/or Bi.

12. The method of claim 8, further comprising removing at least a portion of the metal film from the graphene monolayer after forming the array of nanoscale pores.

13. The method of claim 8, wherein forming the array of colloid particles further comprises forming by one of: dip-coating, curtain coating, contact-lift coating, electrophoretic deposition, chemical deposition, electrochemical deposition, physical template guided deposition, spin coating, spray coating, electrostatic coating, inkjet printing, contact printing. offset printing, or flexography.

14. The method of claim 8, wherein forming the array of colloid particles further comprises forming the array of colloid particles on the surface of the graphene monolayer as a substantially hexagonal close packed array.

15. The method of claim 8, wherein removing the colloid particles further comprises removing by one or more of: etching, contact-lifting, thermal decomposition, and/or sonication.

16. The method of claim 8 further comprising forming the array of colloid particles to include one or more of: a silica, an alumina, silicon, a metal, a polystyrene, a polyacrylate, a polycarbonate, a polyalkane, a polyalkene, a polyester, a polyacrylonitrile, and/or a mixture thereof.

17. The method of claim 8, wherein etching the shadow-masked fraction of the graphene monolayer to form an array of nanoscale pores in the graphene monolayer further comprises etching by one of: electron beam etching, oxygen plasma etching, or chemical oxidation.

18. The method of claim 8, further comprising positioning the porous membrane at a porous support substrate.

19. The method of claim 8, wherein etching the shadow-masked fraction of the surface of the graphene monolayer further comprises etching the nanoscale pores in the graphene monolayer such that the array of nanoscale pores is characterized by a substantially uniform pore diameter.

20. (canceled)

21. (canceled)

22. (canceled)

23. A system for manufacturing a porous membrane, the system comprising:
a deposition chamber;
a sample manipulator configured to position a graphene monolayer at a support substrate in the deposition chamber;
a colloid deposition source;
a metal deposition source, wherein the metal deposition source and the sample manipulator are cooperatively configured to provide off-axis deposition of a metal film to a surface of the graphene monolayer held at the sample manipulator;
a colloid removal apparatus;
an etchant source; and
a microprocessor coupled to the deposition chamber, the sample manipulator, the colloid deposition source, the metal deposition source, the colloid removal apparatus, and the etchant source, wherein the microprocessor is configured via machine executable instructions to:
control the colloid deposition source and the sample manipulator effective to deposit an array of colloid particles on the surface of the graphene monolayer such that the colloid particles define a shadow-masked fraction and an unmasked fraction of the surface of the graphene monolayer;
control the metal deposition source and the sample manipulator effective to coat a metal film on at least a portion of the unmasked fraction of the surface of the graphene monolayer;
control the colloid removal apparatus effective to remove the colloid particles from the shadow-masked fraction of the surface of the graphene monolayer;
control the etchant source to etch the shadow-masked fraction of the surface of the graphene monolayer effective to form an array of nanoscale pores in the graphene monolayer; and
control the sample manipulator effective to release the graphene monolayer from the support substrate to form the porous membrane.

24. The system of claim 23, wherein the microprocessor is further configured via the machine executable instructions to:
control the sample manipulator to contact the porous membrane to a porous support substrate;
control the metal deposition source and the sample manipulator to coat the metal film by one of: ion beam deposition, metal sputtering, electron beam evaporation, chemical vapor deposition, atomic layer deposition, electroplating, or redox precipitation;
control the metal deposition source and the sample manipulator to coat the metal film by off-axis deposition;
control the etchant source to etch at least a portion of the metal film from the graphene monolayer after forming the array of nanoscale pores;
control the etchant source to etch the shadow-masked fraction of the graphene monolayer by one of: electron beam etching, oxygen plasma etching, or chemical oxidation;
control the colloid deposition source to contact the colloid particles to the graphene monolayer by one of: dip-coating, curtain coating, contact-lift coating, electrophoretic deposition, chemical deposition, electrochemical deposition, physical template guided deposition, spin coating, spray coating, electrostatic coating, inkjet printing, contact printing. offset printing, or flexography;
control the colloid removal apparatus to remove the colloid particles by one or more of: etching, contact-lifting, and/or sonication; and/or
control the etchant source to etch at least a portion of the metal film from the unmasked fraction of the surface of the graphene monolayer after the array of nanoscale pores is formed.

25. A computer-readable storage medium having machine executable instructions stored thereon for manufacturing a porous membrane, comprising instructions to:
control a colloid deposition source and a sample manipulator effective to deposit an array of colloid particles on a surface of a graphene monolayer such that the colloid particles define a shadow-masked fraction and an unmasked fraction of the surface of the graphene monolayer;
control a metal deposition source and a sample manipulator effective to coat a metal film on at least a portion of the unmasked fraction of the surface of the graphene monolayer;
control a colloid removal apparatus effective to remove the colloid particles from the shadow-masked fraction of the surface of the graphene monolayer;
control an etchant source to etch the shadow-masked fraction of the surface of the graphene monolayer effective to form an array of nanoscale pores in the graphene monolayer; and
control the sample manipulator effective to release the graphene monolayer from a support substrate to form the porous membrane.

26. The computer-readable storage medium of claim 25, wherein the machine executable instructions to control the metal deposition source and the sample manipulator effective to coat the metal film are configured to control one of: a ion beam depositor, a metal sputtering apparatus, an electron beam evaporator, a chemical vapor deposition apparatus, an atomic layer deposition apparatus, an electroplating apparatus, or an electrochemical apparatus configured to conduct redox precipitation.

27. The computer-readable storage medium of claim 26, wherein the machine executable instructions to control the metal deposition source and the sample manipulator effective to coat the metal film include machine executable instructions to cooperatively control the metal deposition source and the sample manipulator to provide off-axis metal deposition to the graphene monolayer held at the sample manipulator.

28. The computer-readable storage medium of claim 25, further comprising machine executable instructions to:
control the etchant source to etch at least a portion of the metal film from the graphene monolayer after forming the array of nanoscale pores;
control the colloid deposition source and the sample manipulator effective to deposit the array of colloid particles are configured to control one of: a dip-coater, a curtain coater, a contact-lift apparatus, an electrophoretic depositor, a chemical depositor, an electrochemical depositor, a physical template depositor, a spin coater, a spray coater, an electrostatic coater, an inkjet printer, a contact printer, an offset printer, or a flexographic printer;
control the colloid removal apparatus effective to remove the colloid particles are configured to control one or more of: an etchant source, a contact-lift apparatus, and/or a sonicator;
control an etchant source to etch the shadow-masked fraction of the surface of the graphene monolayer are configured to control one of: an electron beam, an oxygen plasma apparatus, or a chemical oxidation apparatus; or
control the sample manipulator to contact the porous membrane to a porous support substrate.
